(19) United States
(12) Patent Application Publication
(10) Pub. No.: US 2011/0052776 A1
(43) Pub. Date: Mar. 3, 2011

(54) CHOCOLATE COMPOSITIONS HAVING IMPROVED FLAVOUR CHARACTERISTICS

(76) Inventors: Emilien Louis Joseph Esteve, Baulmes (CH); Carole Ann Bingley, Reading (GB)

(21) Appl. No.: 12/602,800

(22) PCT Filed: Jul. 9, 2008
(86) PCT No.: PCT/GB2008/002352

§ 371 Date: Apr. 30, 2010

(30) Foreign Application Priority Data
Jul. 10, 2007 (GB) 0713297.0

(51) Int. Cl. A23G 1/32

(52) U.S. Cl. 426/548; 426/631

(57) ABSTRACT

The present invention relates to chocolate compositions which include taste potentiators to enhance the perception of flavouring elements contained therein. More specifically, some embodiments provide chocolate compositions comprising potentiator compositions, which include at least one flavouring element and at least one taste potentiator. The flavouring element and/or taste potentiator may be encapsulated in some embodiments to modify the release rate of the encapsulated element upon consumption.

The present invention relates to the field of chocolate compositions, and particularly includes chocolate compositions that provide an enhanced perception of a flavour therein. In particular, the compositions may include a sweetener, and a sweetness potentiator. The sweetness potentiator may modify the perception of the sweetener upon consumption.

Chocolate is a confectionery foodstuff formed from one or more components of the cocoa bean. In particular, chocolate is formed from solids from cocoa beans, including fats, such as cocoa butter, and a sweetener such as sugar. The taste of the chocolate is typically determined by the quantity and type of fat and sweetener present, as well as the presence of other ingredients such as flavourings.

There are five primary categories of taste that are sensed by humans: sour, salty, sweet, bitter and umami (savoury or the taste of glutamate). The taste of a substance is sensed by taste receptor cells located in taste buds primarily on the surface of the tongue and palate in the oral cavity. Each of the primary taste qualities is sensed by a specific mechanism. It is believed that sour and salty tastes are detected by the passage of ions, hydrogen and sodium respectively, through the ion channels in taste bud cells. This triggers a nerve impulse that is sensed in the brain as sour or salty. In contrast, it is believed that sweet, bitter and umami tastes are perceived by physical binding to receptors. In general, sweet, bitter and umami sensing taste cells have G-protein coupled receptors (GPCRs) on their surface. These receptors are activated when they bind to tastants, which initiates a series of signalling events that trigger a nerve impulse that is sensed in the brain as sweet, bitter or savoury.

Over the past several years, there have been a number of advances in research on taste perception. New taste receptor proteins have been identified in mammals, particularly two families of G-protein coupled receptors (T2Rs and T1Rs), which are believed to be involved in taste perception. Such receptors are discussed in more detail in International Publication Nos. WO 02/064631 and WO 03/001876. These publications disclose that co-expression of certain T1R receptors results in savoury or sweet taste receptors that respond to savoury or sweet taste stimuli, respectively.

Recent advances in the understanding of taste perception have created interest in identifying new compounds for stimulating these taste receptors. In particular, research efforts also have been directed to methods of identifying compounds that may enhance the primary taste perceptions, such as sweet or savoury perceptions. The development of substances that provide flavour enhancement is of particular interest, and such substances are generally referred to as taste or flavour enhancers, or potentiators. These substances have been thought to contribute taste, aroma and feeling factors, as well as potentiate and suppress other flavours. The activity of taste or flavour enhancers is often referred to as synergistic because they enhance or increase the perception of another substance.

One category of taste potentiators of particular interest are compounds that enhance sweetness. Although naturally-occurring carbohydrate sweeteners, such as sucrose, are the most widely used sweeteners, they suffer from the disadvantages of high cost and high caloric content. Artificial sweeteners have been designed that overcome these problems but they are sometimes rejected by the consumer for not having a sufficiently ‘sucrose-like’ taste. Artificial sweeteners have different sweetness profiles from that of sucrose and often suffer from side effects such as delays in the onset of sweetness perception and/or unpleasant aftertastes.

Compounds are known which, when combined with a sweetener, modify the taste of the sweetener. Such compounds are usually referred to as sweetness modifiers or potentiators. They may act to enhance or inhibit the perception of the sweetness of the sweetener or may affect the sweetness profile in some way. For example, Canadian Patent No. 1208966 discloses a broad range of aromatic compounds which are claimed as sweetness modifiers.

European Patent No. 0132444 and U.S. Pat. No. 4,627,987 describe 3-hydroxybenzoic acid (3-HB) as a sweetness potentiator and exemplify its use with sucrose, aspartame and saccharin to enhance sweetness when employed at pH 2.0 to 5.5.

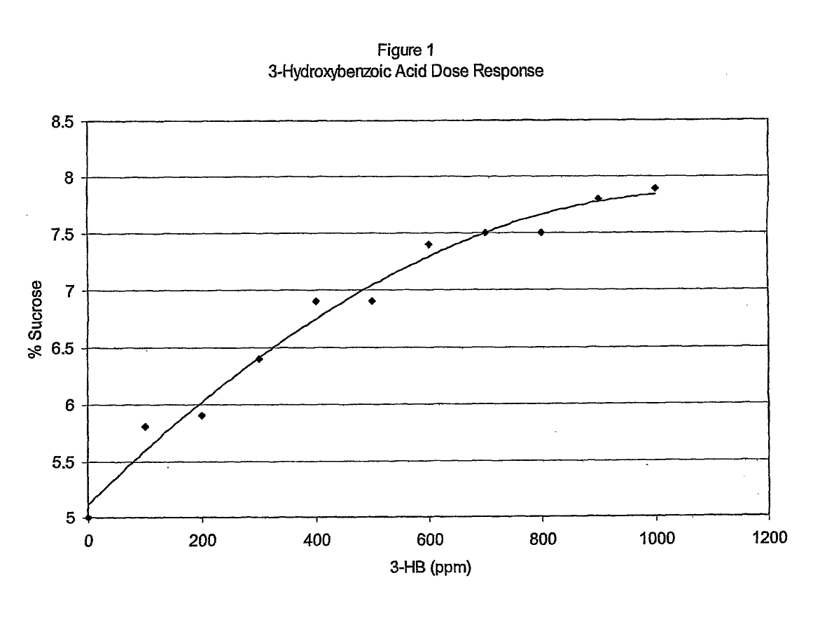

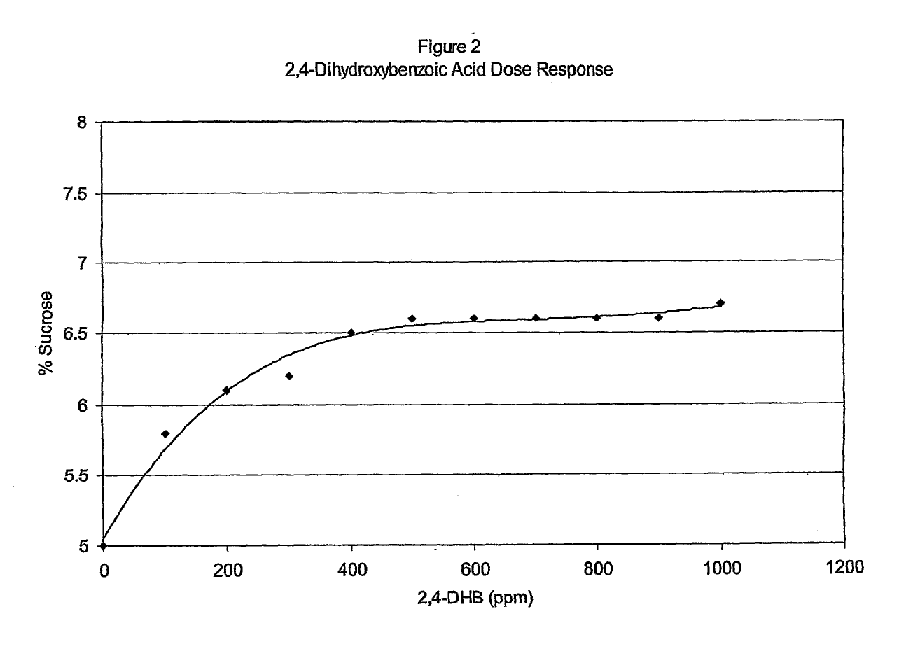

2,4-Dihydroxybenzoic acid (2,4-DHB) also is described as a sweetness potentiator, but the literature is ambiguous as to its effects. In U.S. Pat. No. 5,232,735 it is listed as a ‘substantially tasteless sweetness inhibitor’ whereas in Canadian Patent No. 1208966 the addition of 0.2% 2,4-DHB to a 5% sucrose solution is said to have resulted in an increase in sweetness. International Publication No. WO 99/15032 describes the use of 2,4-DHB with aspartame to increase sweetness synergistically and provide a more ‘sucrose-like’ taste and mouthfeel. The combination is considered peculiar, in that the same effect is not observed when 2,4-DHB is combined with the alternative artificial sweeteners, alitame, Ace-K (acesulfame potassium), saccharin or even a mixture of aspartame and Ace-K. U.S. Pat. No. 6,461,658 claims that 2,4-DHB improves the sweetness delivery profile of the artificial sweetener sucralose by significantly reducing the length of time during which sucralose sweetness is perceived. The same effect is not observed for aspartame even though this might be expected in light of International Publication No. WO 99/15032. FIGS. 1 and 2 and Tables 1 and 2 of U.S. Pat. No. 6,461,658 seem to indicate that 2,4-DHB has a slightly inhibitory effect on the sweetness intensity of both sucralose and aspartame although this is not discussed in the text.

International Publication No. WO 00/69282 describes the modification of the taste and physicochemical properties of the sweetener neotame by the addition of at least one taste modifying hydrophobic acid additive. The taste modifying hydrophobic acid additive is limited only in that it must positively affect at least one taste characteristic imparted by neotame. These characteristics appear to be related to the sweetness profile, specifically the onset and linger period, but the examples do not describe how the characteristics have been affected. 3-HB and 2,4-DHB are listed among a very large number of such additives.

Additionally, there have been a number of recent developments related to methods of identifying substances that function as taste potentiators. Various assays have been developed to identify target compounds that modulate the activity of taste receptors, and thus, may become successful taste potentiators. For example, International Publication Nos. WO 02/064631 and WO 03/001876, referred to above, disclose assays and high-throughput screens that measure certain T1R receptor activity in the presence of target compounds.

U.S. Pat. No. 6,955,887 to Adler et al. discloses methods for identifying taste potentiators using newly identified mammalian taste-cell-specific G-protein coupled receptors. More specifically, U.S. Pat. No. 6,955,887 teaches methods for screening target compounds that may be used to modulate the sweet taste perception.

Various other methods for screening compounds that may be used as taste potentiators are disclosed in the U.S. Patent Publication Nos. 2005/0287517A1, 2005/0084932A1, 2005/0069944A1, 2005/0032158A1, 2004/0229239A1, 2004/0209286A1, 2004/0191805A1, 2004/0185469A1, 2004/0175793A1, 2004/0175792A1, 2004/0171042A1, 2004/0132075A1, 2004/0072254A1, 2003/0232407A1, 2003/0170608A1 and 2003/0054448A1.

Despite progress in developing methods for identifying new taste potentiators, there is still a need for chocolate compositions that have improved taste characteristics. Further, there is a need for chocolate compositions that are low in fat content or in calorific value, and which have improved taste characteristics. Moreover, it would be desirable to develop a chocolate composition that allows the quantity of natural or artificial sweetener therein to be reduced, thereby reducing the cost of production but which avoids adverse effects on flavour.

According to a first aspect of the present invention, there is provided a milk, dark or white chocolate composition comprising at least one taste potentiator. In one embodiment the chocolate composition is a milk chocolate composition.

A typical commercial dark chocolate has a total fat content in the range of 26 wt % to 50 wt %, a typical commercial milk chocolate has a total fat content in the range of 27 wt % to 45 wt % and a typical commercial white chocolate has a total fat content in the range of 31 wt % to 45 wt %.

In one embodiment, the chocolate is aerated.

In one embodiment, the chocolate composition comprises a centrefill coated with chocolate. The centrefill may comprise one or more nuts, fruit (including dried fruit), hard or soft caramel, jelly candy, sugar candy (including sugar-free equivalents), honeycomb candy, biscuit, or other suitable items.

In one embodiment, the chocolate composition is a chocolate-flavoured beverage.

According to a second aspect of the present invention, there is provided a chocolate composition comprising at least one sugar-free sweetener and at least one taste potentiator.

In one embodiment, the at least one sugar-free sweetener comprises a sugar alcohol. In a further embodiment, the at least one sugar-free sweetener comprises erythritol. Other suitable sugar alcohols include sorbitol, mannitol, maltitol, xylitol, isomalt and mixtures thereof, for example. In a still further embodiment, the chocolate composition does not comprise inulin or fructo oligosaccharide (FOS).

In a further embodiment, the sugar-free sweetener comprises erythritol and the chocolate composition further comprises at least one ingredient chosen from maltodextrin, a high protein ingredient, maltitol and polydextrose.

In a still further embodiment, the chocolate composition comprises up to 30 wt %, and may comprise from 1.5 to 10 wt %, maltodextrin.

In another embodiment, the chocolate composition comprises up to 20 wt %, and may comprise from 1 to 4 wt %, of a high protein ingredient.

In another embodiment, the chocolate composition comprises up to 25 wt %, and may comprise from 5 to 10 wt %, maltitol.

In another embodiment, the chocolate composition comprises up to 20 wt %, and may comprise from 5 to 10 wt %, polydextrose.

Dextrins are a group of low molecular weight carbohydrates produced by the hydrolysis of starch. Maltodextrin (CAS registry number 9050-36-6) is a cyclodextrin (a cyclical dextrin) that can be derived from any starch but is most commonly derived from corn, potato, wheat or barley. It is commonly used as a bulking agent and as a diluent in pharmaceutical applications.

A ‘high protein ingredient’ is an ingredient that is constituted by at least 40 wt % protein and includes ingredients such as whey protein. Whey protein is isolated from whey (the watery liquid left when milk forms curds). It is commonly used as a nutritional supplement, particularly among bodybuilders, and is typically sold in three forms: concentrate, isolate and hydrolysate. The concentrate contains low levels of fat and carbohydrate in the form of lactose. The isolate is processed to remove fat and lactose and consequently tends to contain a higher proportion of protein. The hydrolysates are partially hydrolysed. Other suitable high protein ingredients include casein, whey proteins (including whey protein concentrate, whey protein isolate and whey protein hydrolysate), sweet whey, milk protein, pea protein, soy protein, and any combination thereof.

In one embodiment, the chocolate composition comprises from 5 wt % to 70 wt % sugar-free sweetener. In a further embodiment, the chocolate composition comprises from 20 wt % to 45 wt % sugar-free sweetener.

In one embodiment, the chocolate composition has a total fat composition of from 15 wt % to 26 wt %. In certain embodiments the chocolate composition of the invention may have a total fat content of at least 16 wt %, of at least 17.5 wt %, of at least 19 wt % or of at least 20 wt %. In certain embodiments the chocolate composition of the invention may have a total fat content of no more than 24 wt %, no more than 22.5 wt %, or no more than 21.5 wt %.

The chocolate composition of the present invention may have a reduced calorie content as compared to a standard fat chocolate. A standard fat chocolate has a calorie content of around 500-550 calories per 100 g. Preferably, the chocolate composition of the present invention has a reduction in calories of at least 10% as compared to standard fat chocolate, more preferably at least 20% as compared to a standard fat chocolate and most preferably at least 30% as compared to a standard fat chocolate. The chocolate composition of the present invention may in some embodiments have a calorie content of from 405 to 450 calories per 100 g, or from 355 to 415 calories per 100 g or from 330 to 370 calories per 100 g.

According to all aspects of the present invention, the chocolate may further comprise flavourings such as vanilla, orange or mint.

As used herein the transitional term ‘comprising,’ (also ‘comprises,’ etc.) is inclusive or open-ended and does not exclude additional, unrecited elements or method steps, regardless of its use in the preamble or the body of a claim.

The chocolate composition may be moulded or extruded to form a bar (filled or solid), it may be moulded or deposited to form a solid or a filled chocolate which may be of single mouthful size, or it may take the form of vermicelli chocolate, chocolate flakes or gianduja nut chocolate derived from any of such chocolate types. Alternatively, it may be used as a coating chocolate.

The chocolate composition comprises at least one fat. The fat may be cocoa butter, butterfat, a cocoa butter equivalent (CBE), a cocoa butter replacer (CBR), a vegetable fat that is liquid at standard ambient temperature and pressure (SATP, 25° C. and 100 kPa) or any combination of the above. The chocolate composition preferably comprises cocoa butter.

CBE's are defined in Directive 2000/36/EC as complying with the following criteria:

a) they are non-lauric vegetable fats, which are rich in symmetrical monounsaturated triglycerides of the type POP, POSt and StOSt;
b) they are miscible in any proportion with cocoa butter, and are compatible with its physical properties (melting point and crystallisation temperature, melting rate, need for tempering phase);
c) they are obtained only by the processes of refining and/or fractionation, which excludes enzymatic modification of the triglyceride structure.

Suitable CBE's include illipe, Borneo tallow, tengkawang, palm oil, sal, shea, kokum gurgi and mango kernel. CBE's are preferably used in combination with cocoa butter. The chocolate composition preferably comprises no more than 5 wt % CBE's.

The chocolate composition may comprise a cocoa butter substitute (CBS) (sometimes known as a cocoa butter replacer, CBR) in place of some or all of the cocoa butter. Such chocolate compositions are sometimes known as compound chocolate. Suitable CBS's include CBS laurics and CBS non-laurics. CBS laurics are short-chain fatty acid glycerides. Their physical properties vary but they all have triglyceride configurations that make them compatible with cocoa butter. Suitable CBS's include those based on palm kernel oil and coconut oil. CBS non-laurics consist of fractions obtained from hydrogenated oils. The oils are selectively hydrogenated with the formation of trans acids, which increases the solid phase of the fat. Suitable sources for CBS nonlaurics include soya, cottonseed, peanut, rapeseed and corn (maize) oil.

The chocolate composition may comprise at least one vegetable fat that is liquid at standard ambient temperature and pressure (SATP, 25° C. and 100 kPa). A liquid vegetable fat may be employed when a liquid chocolate composition is desired. Suitable vegetable fats include corn oil, cotton seed oil, rapeseed oil, palm oil, safflower oil, and sunflower oil.

The present invention is further applicable to chocolate compositions in which some or all of the fat is constituted by a partly or wholly non-metabolisable fat, for example Caprenin.

Embodiments described herein provide chocolate compositions comprising a taste potentiator. The chocolate composition may comprise various flavouring elements which contribute to the taste of the chocolate, including for example sugar or sugar-free sweeteners, substances obtained from cocoa beans, and other flavourings. The flavouring elements may act to produce a single combined flavour, or may produce more than one complementary or contrasting flavours. The taste potentiator may act in a synergistic manner when used in conjunction with the flavouring elements to enhance the perception of the flavouring elements during consumption.

In some embodiments, the taste potentiator my be in the form of a crystalline solid, or an amorphous solid, or a liquid. Additionally or alternatively, in some embodiments, the taste potentiator may be encapsulated to provide a controlled release profile, i.e., delayed or increased rate of release upon consumption. The taste potentiator accordingly may release over an extended period of time throughout the consumption of the product into which the chocolate composition is incorporated, such as for example a coated chocolate item.

The chocolate composition may include a plurality of taste potentiators. As used herein, references to ‘the taste potentiator’ may refer to a single taste potentiator or to any combination of multiple taste potentiators present in the chocolate composition.

As used herein, the term ‘flavouring element’ may include any ingredient which contributes a perceptible taste to the chocolate composition. For example, the term may include sweeteners (which may be sugars or sugar-free sweeteners) or flavourings. The term ‘flavourings’ is well understood in the art and refers to elements (such as fruit and vegetable oils) added to a composition chiefly for the purpose of altering the taste perception of that composition. In some embodiments, the perceptible flavours produced by such flavourings are more complex than the five basic categories of taste discussed above.

In some embodiments, the flavouring element may be a sweetener. Delivery of the sweetener in combination with at least one taste potentiator may enhance the sweet taste upon consumption of the composition. In particular, the taste potentiator may function synergistically with the sweetener to enhance the sweet taste. The incorporation of the potentiator may, therefore, allow for reduced amounts of sweetener to be included in the chocolate composition without compromising the level of sweetness provided by the composition. Due to the calories contained in many conventional sweeteners, such as sugar, or health issues associated with consumption of large quantities of sugar-free sweeteners, these results may be highly desirable. Additionally, there may be significant cost savings associated with the reduction in sweetener amounts used in the composition.

For purposes of some embodiments described herein, ‘taste potentiator’ refers to substances that may enhance the perception of a flavouring element during consumption of the chocolate composition. For purposes of some embodiments described herein, the term ‘enhance’ means to intensify, supplement, modify, modulate or potentiate. Some taste potentiators may be referred to more specifically by reference to the type of flavouring element they enhance. For example, sweetener (or sweetness) potentiators enhance the perception of a sweetener during consumption and flavour potentiators enhance the perception of a flavour during consumption. These more specific examples, however, are merely subsets of taste potentiators and are encompassed by the general term ‘taste potentiator’ as used herein.

Some taste potentiators may also act to suppress undesirable flavours, and thereby improve the perception of a desired flavour. For example, in some embodiments taste potentiators may act to reduce or suppress ‘harsh’ or ‘bitter’ flavours associated with cocoa or other flavouring elements.

Taste potentiators may have a synergistic effect when used in conjunction with a flavouring element, i.e., by enhancing the taste effects of the flavouring element such that the total effect is greater than the sum of the taste effects of the individual substances alone. In addition, some taste potentiators do not introduce a characteristic taste and/or aroma perception of their own.

In some embodiments, for instance, the taste potentiator(s) may enhance the sour, sweet, bitter, salty or umami taste of a composition. The taste potentiator(s) also may function to enhance the effects of a variety of other flavouring elements, as discussed in more detail below.

Any of a variety of known substances that function as taste potentiators may be employed in the compositions described herein. For instance, suitable taste potentiators include water-soluble taste potentiators, such as, but not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), water-soluble sugar acids, potassium chloride, sodium acid sulfate, water-soluble hydrolyzed vegetable proteins, water-soluble hydrolyzed animal proteins, water-soluble yeast extracts, adenosine monophosphate (AMP), glutathione, water-soluble nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, 2-hydroxybenzoic acid (2-HB), 3-hydroxybenzoic acid (3-HB), 4-hydroxybenzoic acid (4-HB), 2,3-dihydroxybenzoic acid (2,3-DHB), 2,4-dihydroxybenzoic acid (2,4-DHB), 2,5-dihydroxybenzoic acid (2,5-DHB), 2,6-dihydroxybenzoic acid (2,6-DHB), 3,4-dihydroxybenzoic acid (3,4-DHB), 3,5-dihydroxybenzoic acid (3,5-DHB), 2,3,4-trihydroxybenzoic acid (2,3,4-THB), 2,4,6-trihydroxybenzoic acid (2,4,6-THB), 3,4,5-trihydroxybenzoic acid (3,4,5-THB), 4-hydroxyphenylacetic acid, 2-hydroxyisocaproic acid, 3-hydroxycinnamic acid, 3-aminobenzoic acid, 4-aminobenzoic acid and combinations thereof.

Other suitable taste potentiators are substantially or completely insoluble in water, such as, but not limited to, citrus aurantium, vanilla oleoresin, water insoluble sugar acids, water insoluble hydrolyzed vegetable proteins, water insoluble hydrolyzed animal proteins, water insoluble yeast extracts, insoluble nucleotides, sugarcane leaf essence and combinations thereof.

Some other suitable taste potentiators include substances that are slightly soluble in water, such as, but not limited to, maltol, ethyl maltol, vanillin, slightly water-soluble sugar acids, slightly water-soluble hydrolyzed vegetable proteins, slightly water-soluble hydrolyzed animal proteins, slightly water-soluble yeast extracts, slightly water-soluble nucleotides and combinations thereof.

Additional suitable taste potentiators include, but are not limited to, liquorice glycyrrhizinates, compounds that respond to G-protein coupled receptors (T2Rs and T1Rs), G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. ‘Kokumi’ refers to materials that impart ‘mouthfulness’ and ‘good body’. Kokumi imparting compositions may be water-soluble, slightly water-soluble or insoluble in water.

As mentioned above, sweetener potentiators, which are a type of taste potentiator, enhance the taste of sweetness. Exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs), 2-hydroxybenzoic acid (2-HB), 3-hydroxybenzoic acid (3-HB), 4-hydroxybenzoic acid (4-HB), 2,3-dihydroxybenzoic acid (2,3-DHB), 2,4-dihydroxybenzoic acid (2,4-DHB), 2,5-dihydroxybenzoic acid (2,5-DHB), 2,6-dihydroxybenzoic acid (2,6-DHB), 3,4-dihydroxybenzoic acid (3,4-DHB), 3,5-dihydroxybenzoic acid (3,5-DHB), 2,3,4-trihydroxybenzoic acid (2,3,4-THB), 2,4,6-trihydroxybenzoic acid (2,4,6-THB), 3,4,5-trihydroxybenzoic acid (3,4,5-THB), 4-hydroxyphenylacetic acid, 2-hydroxyisocaproic acid, 3-hydroxycinnamic acid, 3-aminobenzoic acid, 4-aminobenzoic acid and combinations thereof.

Additional taste potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g. zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

The sensation of warming or cooling effects may also be prolonged with the use of a hydrophobic sweetener as described in U.S. Patent Publication No. 2003/0072842 A1, which is incorporated in its entirety herein by reference. For example, such hydrophobic sweeteners include those of the formulae I XI as set forth below:

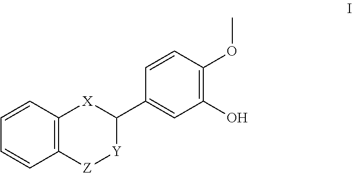

wherein X, Y and Z are selected from the group consisting of CH2, O and S;

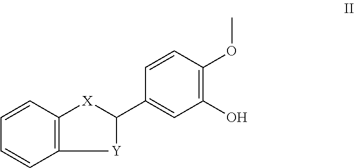

wherein X and Y are selected from the group consisting of S and O;

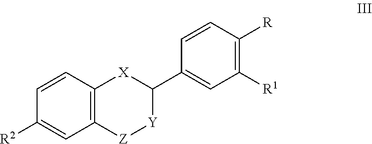

wherein X is S or O; Y is O or CH2; Z is CH2, SO2 or S; R is OCH3, OH or H; R1 is SH or OH and R2 is H or OH;

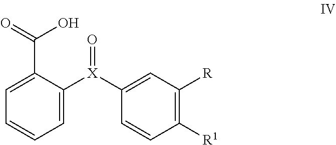

wherein X is C or S; R is OH or H and R1 is OCH3 or OH;

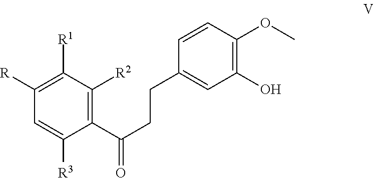

wherein R, R2 and R3 are OH or H and R1 is H or COOH;

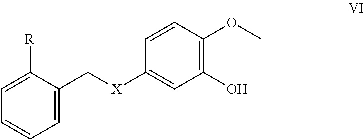

wherein X is O or CH2 and R is COOH or H;

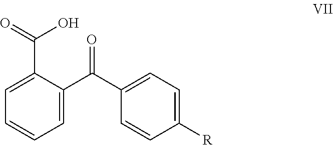

wherein R is CH3CH2, OH, N (CH3)2 or Cl;

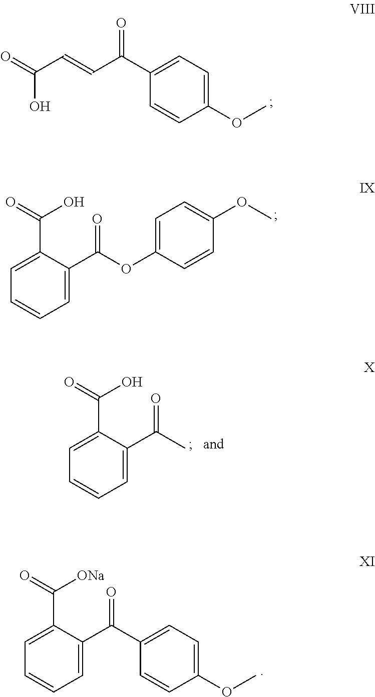

Perillartine may also be added as described in U.S. Pat. No. 6,159,509 also incorporated in its entirety herein by reference.

Any of the above-listed taste potentiators may be used alone or in combination.

Some embodiments, for instance, may include two or more taste potentiators that act synergistically with one another. For instance, in some embodiments, a sweetener potentiator composition may be provided, which includes two or more sweetener potentiators that act synergistically with one another. The sweetener potentiator composition may enhance the sweetness of products into which it is incorporated by reducing the amount of sucrose needed to provide a sweetness intensity equivalent to sucrose. The sweetness enhancing effect of the combination of sweetener potentiators may be greater than the effect of either compound used individually.

More specifically, according to some embodiments, there is provided chocolate composition, comprising a sweetener potentiator composition comprising 3-hydroxybenzoic acid (3-HB) and 2,4-dihydroxybenzoic acid (2,4-DHB) or comestible salts thereof.

Comestible salts include acid (i.e. carboxylate) salts and/or hydroxylate salts, especially sodium, potassium, calcium, magnesium, and ammonium salts and the like. Desirably, in some embodiments, the sweetener potentiator composition employs 3-HB and/or 2,4-DHB in the form of the acid, the sodium salt or the potassium salt.

The inventors have discovered that a surprisingly large sweetness enhancing effect is observed when both compounds are employed in combination with a sweetener. This effect is greater than would be predicted by the use of either compound individually.

In particular, in some embodiments, sufficient amounts of 3-HB and 2,4-DHB are employed in the sweetener potentiator compositions to create a sucrose equivalent value of at least about 7%, more specifically, at least about 8%.

In general, 3-HB and 2,4-DHB may be used in amounts of about 200 ppm, 400 ppm or 500 ppm. 3-HB and 2,4-DHB may be incorporated into sweetener potentiator compositions in equal or different amounts.

In some embodiments, the sweetener potentiator composition contains 3-HB and 2,4-DHB in a ratio by weight of from 1:9 to 9:1, more specifically from 2:8 to 8:2, even more specifically from 4:6 to 6:4 and most specifically 1:1.

The sweetener potentiator composition may contain a further sweetener potentiator. For instance, 3,4-dihydroxybenzoic acid (3,4-DHB) or its comestible salt may be employed.

In some embodiments, the sweetness potentiator composition may comprise maltitol and at least one sweetness potentiator selected from 2,4-dihydroxybenzoic acid, 3-hydroxybenzoic acid and 3-aminobenzoic acid. In some embodiments, the sweetness potentiator composition may comprise maltitol and at least two sweetness potentiators selected from 2,4-dihydroxybenzoic acid, 3-hydroxybenzoic acid and 3-aminobenzoic acid. The sweetness potentiator composition may comprise between 30 and 55 wt % maltitol, more specifically between 40 and 50 wt % maltitol, and in some embodiments may be free from sucrose.

In some embodiments, the chocolate composition may be free from sucrose.

In some embodiments, the sweetener potentiator composition may be provided as a pre-blended powder or liquid, which may be added to another composition, whereas in other embodiments, the individual components of the sweetener potentiator composition may be added to another composition as individual ingredients.

In some embodiments, it may be desirable to control the release rate of the taste potentiator from the compositions, as well as the overall release profile of the compositions themselves. Different release rates may be desired depending on the type of final product in which the composition is being incorporated and the consumption time thereof.

In some embodiments, the release rate may be based on the solubility of the taste potentiator(s) in water. Selection of a specific solubility may be used to control the release profile of the taste potentiator(s), as well as the overall composition. More specifically, taste potentiators have varying solubilities in water. Although some of these components are water-soluble, i.e. capable of being substantially or completely dissolved in water, others exhibit poor or no solubility in water. In some embodiments, for instance, it may be desirable to select one or more taste potentiators that have low water-solubility in combination with a flavouring element known to exhibit poor solubility in water. The highly insoluble taste potentiator thereby may last throughout consumption of the composition as the flavouring element also slowly releases therefrom. Alternatively, a relatively highly water-soluble potentiator may be paired with a relatively highly water-soluble active substance. In both of these instances, the taste potentiator and active substance may be selected based on solubilities such that their release profiles are similar or overlap.

In other embodiments, for example, it may be desirable to select several taste potentiators that have different solubilities in water such that the potentiators may release sequentially from the composition. Another example may include multiple sequentially releasing taste potentiators with multiple active substances also having different solubilities in water. Numerous other combinations of taste potentiators having different solubilities also may be used to provide different release profiles for the compositions. In view thereof, the solubility of the taste potentiator(s), as well as the combination thereof with the flavouring element(s), may be used to control and tailor the release profile of the overall composition.

For purposes of some embodiments described herein, therefore, the term ‘controlled-release’ means that the duration or manner of release is managed or modified to some degree to provide a desired release profile. More specifically, for example, controlled-release includes at least the following release profiles: delayed onset of release; pulsed release; gradual release; high initial release; sustained release; sequential release; and combinations thereof.

Taste potentiators and active substances having different solubilities and/or release profiles may be combined in numerous different embodiments to provide compositions having many different overall release profiles. For example, one or more taste potentiators having any of the following release profiles may be combined in any manner with one or more active substances having any of the following release profiles: delayed onset of release (‘DOR’); pulsed release (‘PR’); gradual release (‘GR’); high initial release (‘HIR’); and sustained release (‘SUR’). Moreover, other techniques of imparting these, as well as other controlled-release profiles to taste potentiators and/or flavouring elements may be employed. For instance, encapsulation techniques, which are discussed in more detail below, may be used. Additionally, taste potentiator(s) and flavouring element(s) that are not encapsulated (sometimes referred to as ‘free’ components) may be combined with other forms of the components, such as encapsulated forms, to tailor the release profile of the potentiator compositions. A sampling of hypothetical combinations is provided in Table 1 below, wherein P1-P3 represent different taste potentiators and A1-A3 represent different active substances. P1-P3 and A1-A3 may be used in their free and/or encapsulated forms.

TABLE 1

| Hypothetical | | | | | | |
|---|---|---|---|---|---|---|
| Combinations | P1 | P2 | P3 | A1 | A2 | A3 |
| 1 | GR | HIR | | GR | HIR | |
| 2 | | GR | HIR | | GR | HIR |
| 3 | PR | SUR | GR | PR | SUR | GR |
| 4 | | PR | SUR | | PR | SUR |
| 5 | HI | | PR | HI | | PR |
| 6 | DOR | HIR | | DOR | HIR | |
| 7 | | DOR | HIR | | DOR | HIR |
| 8 | | | DOR | PR | | DOR |
| 9 | SUR | HIR | | | PR | |
| 10 | | SUR | HIR | | | PR |

Controlled-release properties also may be imparted to the compositions described herein in other manners, such as, for example, by encapsulation techniques, as mentioned above. Encapsulation may be used to impart any of the various release profiles discussed above. In some embodiments, the taste potentiator(s) and/or flavouring element(s) may be encapsulated to control the rate of release of the potentiator and/or flavouring element from the composition. For example, in some embodiments, 3-HB and/or 2,4-DHB may be used in their encapsulated forms.

For instance, some embodiments may include at least one encapsulated taste potentiator and at least one unencapsulated flavouring element, i.e. in its free form. Other embodiments may include at least one unencapsulated taste potentiator and at least one encapsulated flavouring element. Further, in some embodiments, both the taste potentiator(s) and flavouring element(s) may be encapsulated. In such embodiments, the taste potentiator(s) and flavouring element(s) may be encapsulated together or separately. In embodiments in which the taste potentiator(s) and flavouring element(s) are encapsulated separately, the material used to encapsulate the components may be the same or different. Furthermore, in any of these embodiments, more than one material may be used to encapsulate the taste potentiator(s) or the flavouring element(s).

In any of the embodiments mentioned above, the encapsulated form of the taste potentiator(s) or flavouring element(s) may be used in combination with an amount of the same component in its free, i.e. unencapsulated, form. By using both the free component and the encapsulated component, the enhanced perception of the flavouring element may be provided over a longer period of time and/or perception of the flavouring element by a consumer may be improved. For instance, some embodiments may include a taste potentiator that is encapsulated in combination with an amount of the same taste potentiator in its unencapsulated form. Alternatively, the unencapsulated taste potentiator could be a different taste potentiator from the potentiator that is encapsulated. Thereby, a mixture of two different taste potentiators may be included in some embodiments, one of which is encapsulated and the other in its free form. These variations also may be employed with respect to the flavouring element(s).

Encapsulation may be effected by dispersion of the components, spray drying, spray coating, fluidized bed drying, absorption, adsorption, coacervation, complexation, or any other standard technique. In general, the taste potentiator(s) and/or flavouring element(s) may be encapsulated by an encapsulant. For purposes of some embodiments described herein, the term ‘encapsulant’ refers to a material that can fully or partially coat or enrobe another substance. Encapsulation is also meant to include adsorption of a substance onto another substance and the formation of agglomerates or conglomerates between two substances.

Any material conventionally used as an encapsulant in edible products may be employed. In some embodiments, for instance, it may be desirable to use an encapsulant that delays the release of the taste potentiator(s), such as, for example, a hydrophobic encapsulant. In contrast, in other embodiments, it may be desirable to increase the rate of release by using an encapsulant such as, for example, a hydrophilic material. Moreover, more than one encapsulant may be used. For example, a taste potentiator or a flavouring element may be encapsulated by a mixture of two or more encapsulants to tailor the rate of release.

It is believed that taste potentiators can act in conjunction with flavouring elements to enhance their activity. In some embodiments, therefore, it may be desirable to control the release of the potentiator(s) such that it substantially coincides with that of the flavouring element(s) included in the composition. As discussed above, some taste potentiators have rapid release rates, whereas other taste potentiators have slower release rates. Meanwhile, some flavouring elements have rapid release rates, whereas others have slower release rates. In some embodiments, the material used to encapsulate the taste potentiator(s) may be selected to delay or increase the release rate of the potentiator(s) based on the release profiles of both the potentiator(s) and flavouring element(s) selected for use together in the composition.

More specifically, in some embodiments, the flavouring element(s) contained in the composition may have a slower release profile than the taste potentiator(s) selected for use in the same composition. It may be desirable, therefore, to delay the release of the taste potentiator(s) from the composition such that it releases substantially in conjunction with the flavouring element(s). The corresponding release profile may increase the effectiveness of the taste potentiator(s) in enhancing the perception of the flavouring element(s) throughout consumption.

Suitable encapsulants for use in delayed release embodiments include, but are not limited to, polyvinyl acetate, polyethylene, crosslinked polyvinyl pyrrolidone, polymethylmethacrylate, polylactidacid, polyhydroxyalkanoates, ethylcellulose, polyvinyl acetatephthalate, methacrylicacid-co-methylmethacrylate and combinations thereof.

In some embodiments, as mentioned above, the taste potentiator(s) may be water-soluble. For example, the following taste potentiators are water-soluble: neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), water-soluble sugar acids, potassium chloride, sodium acid sulfate, water-soluble hydrolyzed vegetable proteins, water-soluble hydrolyzed animal proteins, water-soluble yeast extracts, adenosine monophosphate (AMP), glutathione, water-soluble nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, 2-hydroxybenzoic acid (2-HB), 3-hydroxybenzoic acid (3-HB), 4-hydroxybenzoic acid (4-HB), 2,3-dihydroxybenzoic acid (2,3-DHB), 2,4-dihydroxybenzoic acid (2,4-DHB), 2,5-dihydroxybenzoic acid (2,5-DHB), 2,6-dihydroxybenzoic acid (2,6-DHB), 3,4-dihydroxybenzoic acid (3,4-DHB), 3,5-dihydroxybenzoic acid (3,5-DHB), 2,3,4-trihydroxybenzoic acid (2,3,4-THB), 2,4,6-trihydroxybenzoic acid (2,4,6-THB), 3,4,5-trihydroxybenzoic acid (3,4,5-THB), 4-hydroxyphenylacetic acid, 2-hydroxyisocaproic acid, 3-hydroxycinnamic acid, 3-aminobenzoic acid, 4-aminobenzoic acid and combinations thereof. Due to their water-solubility, such taste potentiators may tend to release rapidly from the compositions into which they are incorporated. As such, in some embodiments, water-soluble taste potentiators may be encapsulated by an encapsulant that delays the release of the potentiator(s), as provided above.

In other embodiments, it may be desirable to increase the release of the taste potentiator(s) from the composition. For instance, the taste potentiator(s) included in the composition may have a slower release rate than the flavouring element(s) selected for use in combination therewith. This difference in release rates may reduce the effectiveness of the taste potentiator(s). Accordingly, such taste potentiators may be encapsulated with an encapsulant that increases the rate of the potentiator's release. Thereby, the release of the potentiator(s) and the flavouring element(s) may substantially coincide during consumption.

Suitable encapsulants for use in increased release embodiments include, but are not limited to, cyclodextrins, sugar alcohols, starch, gum arabic, polyvinylalcohol, polyacrylic acid, gelatin, guar gum, fructose and combinations thereof.

In some embodiments, as mentioned above, the taste potentiator(s) may be substantially or completely insoluble in water. For example, the following taste potentiators are substantially or completely water-insoluble: citrus aurantium, vanilla oleoresin, water insoluble sugar acids, water insoluble hydrolyzed vegetable proteins, water insoluble hydrolyzed animal proteins, water insoluble yeast extracts, insoluble nucleotides, sugarcane leaf essence and combinations thereof. Due to their poor solubility in water, such taste potentiators may tend to release slowly from the compositions. As such, in some embodiments, substantially or completely water-insoluble taste potentiators may be encapsulated by an encapsulant that increases the release of the potentiator(s), as provided above.

In accordance with the above, the encapsulated taste potentiator may include a taste potentiator and an encapsulant. The encapsulant may be selected based upon the desired release profile of the taste potentiator. In some embodiments, the taste potentiator(s) may be present in amounts of about 0.01% to about 10% by weight of the composition, more specifically about 0.1% to about 2% by weight of the composition.

In some embodiments, the encapsulant may be present in amounts of about 1% to about 95% by weight of the composition, more specifically about 5% to about 30% by weight of the composition.

In some embodiments, the encapsulated substance, i.e. encapsulated taste potentiator(s) or flavouring element(s), may have a high tensile strength, such as at least about 6,500 psi. More specifically, the tensile strength may be about 6,500 psi to about 200,000 psi. Such tensile strengths may be suitable for controlling the release of the taste potentiator(s) and/or flavouring element(s) in a consistent manner over an extended period of time. Tensile strengths of encapsulated substances are described in more detail in U.S. Patent Publication No. 2005/0112236 A1, the contents of which are incorporated by reference herein.

The flavouring element(s) may be any component for which the perception is enhanced in some manner by the presence of one or more taste potentiators. Suitable flavouring elements include, but are not limited to, compounds that provide flavour, sweetness, tartness, umami, kokumi, savoury, saltiness, cooling, warmth or tingling. Combinations of flavouring elements also may be employed.

Flavouring elements which may be used include those flavours known to the skilled artisan, such as natural and artificial flavours. These flavourings may be chosen from synthetic flavour oils and flavouring aromatics and/or oils, oleoresins and extracts derived from plants, leaves, flowers, fruits, and so forth, and combinations thereof. Nonlimiting representative flavour oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavourings are artificial, natural and synthetic fruit flavours such as vanilla, and citrus oils including lemon, orange, lime, grapefruit, yazu, sudachi, and fruit essences including apple, pear, peach, grape, blueberry, strawberry, raspberry, cherry, plum, pineapple, watermelon, apricot, banana, melon, apricot, ume, cherry, raspberry, blackberry, tropical fruit, mango, mangosteen, pomegranate, papaya and so forth. Other potential flavours include a milk flavour, a butter flavour, a cheese flavour, a cream flavour, and a yogurt flavour; a vanilla flavour; tea or coffee flavours, such as a green tea flavour, an oolong tea flavour, a tea flavour, a cocoa flavour, a chocolate flavour, and a coffee flavour; mint flavours, such as a peppermint flavour, a spearmint flavour, and a Japanese mint flavour; spicy flavours, such as an asafetida flavour, an ajowan flavour, an anise flavour, an angelica flavour, a fennel flavour, an allspice flavour, a cinnamon flavour, a camomile flavour, a mustard flavour, a cardamom flavour, a caraway flavour, a cumin flavour, a clove flavour, a pepper flavour, a coriander flavour, a sassafras flavour, a savory flavour, a Zanthoxyli Fructus flavour, a perilla flavour, a juniper berry flavour, a ginger flavour, a star anise flavour, a horseradish flavour, a thyme flavour, a tarragon flavour, a dill flavour, a capsicum flavour, a nutmeg flavour, a basil flavour, a marjoram flavour, a rosemary flavour, a bayleaf flavour, and a wasabi (Japanese horseradish) flavour; alcoholic flavours, such as a wine flavour, a whisky flavour, a brandy flavour, a rum flavour, a gin flavour, and a liqueur flavour; floral flavours; and vegetable flavours, such as an onion flavour, a garlic flavour, a cabbage flavour, a carrot flavour, a celery flavour, mushroom flavour, and a tomato flavour. These flavouring agents may be used in liquid or solid form and may be used individually or in admixture. Commonly used flavours include mints such as peppermint, menthol, spearmint, artificial vanilla, cinnamon derivatives, and various fruit flavours, whether employed individually or in admixture. Flavours may also provide breath freshening properties, particularly the mint flavours when used in combination with cooling agents.

Other useful flavourings include aldehydes and esters such as cinnamyl acetate, cinnamaldehyde, citral diethylacetal, dihydrocarvyl acetate, eugenyl formate, p-methylamisol, and so forth may be used. Generally any flavouring or food additive such as those described in Chemicals Used in Food Processing, publication 1274, pages 63-258, by the National Academy of Sciences, may be used. This publication is incorporated herein by reference.

Further examples of aldehyde flavourings include but are not limited to acetaldehyde (apple), benzaldehyde (cherry, almond), anisic aldehyde (liquorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavours), butyraldehyde (butter, cheese), valeraldehyde (butter, cheese), citronellal (modified, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, strawberry shortcake, and mixtures thereof.

In some embodiments, the flavour agent may be employed in either liquid form and/or dried form. When employed in the latter form, suitable drying means such as spray drying the oil may be used. Alternatively, the flavour agent may be absorbed onto water soluble materials, such as cellulose, starch, sugar, maltodextrin, gum arabic and so forth or may be encapsulated. The actual techniques for preparing such dried forms are well-known.

In some embodiments, the flavour agents may be used in many distinct physical forms well-known in the art to provide an initial burst of flavour and/or a prolonged sensation of flavour. Without being limited thereto, such physical forms include free forms, such as spray dried, powdered, beaded forms, encapsulated forms, and mixtures thereof.

Compounds that provide sweetness (sweeteners or sweetening agents) may include bulk sweeteners such as sugars, sugarless bulk sweeteners, or the like, or mixtures thereof. Suitable sugar sweeteners generally include mono-saccharides, di-saccharides and poly-saccharides such as but not limited to, sucrose (sugar), dextrose, maltose, dextrin, xylose, ribose, glucose, lactose, mannose, galactose, fructose (levulose), invert sugar, fructo oligo saccharide syrups, partially hydrolyzed starch, corn syrup solids, isomaltulose and mixtures thereof.

Suitable sugarless bulk sweeteners include sugar alcohols (or polyols) such as, but not limited to, sorbitol, xylitol, mannitol, galactitol, maltitol, hydrogenated isomaltulose (ISOMALT), lactitol, erythritol, hydrogenated starch hydrolysate, stevia and mixtures thereof.

Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, high-intensity sweeteners may be used. Without being limited to particular sweeteners, representative categories and examples include:
(a) water-soluble sweetening agents such as dihydrochalcones, monellin, stevia, steviosides, rebaudioside A, glycyrrhizin, dihydroflavenol, and sugar alcohols such as sorbitol, mannitol, maltitol, xylitol, erythritol and L-aminodicarboxylic acid aminoalkenoic acid ester amides, such as those disclosed in U.S. Pat. No. 4,619,834, which disclosure is incorporated herein by reference, and mixtures thereof;
(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;
(c) dipeptide based sweeteners, such as L-aspartic acid derived sweeteners, such as L-aspartyl-L-phenylalanine methyl ester (Aspartame) and materials described in U.S. Pat. No. 3,492,131, L-alphaaspartyl-N-(2,2,4,4-tetramethyl-3-thietanyl)-D-alaninamide hydrate (Alitame), N-[N-(3,3-dimethylbutyl)-L-aspartyl]-L-phenylalanine 1-methyl ester (Neotame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;
(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-f uranoside, or 4,1′-dichloro-4,1′-dideoxygalactosucrose; 1′,6′-dichloro-1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalactosucrose; and 4,6,1′,6′-tetradeoxysucrose, and mixtures thereof;
(e) protein based sweeteners such as thaumatococcus danielli (Thaumatin I and II) and talin;
(f) the sweetener monatin (2-hydroxy-2-(indol-3-ylmethyl)-4-aminoglutaric acid) and its derivatives; and
(g) the sweetener Lo han guo (sometimes also referred to as ‘Lo han kuo’).

The intense sweetening agents may be used in many distinct physical forms well known in the art to provide an initial burst of sweetness and/or a prolonged sensation of sweetness. Without being limited thereto, such physical forms include free forms, such as spray dried, powdered, beaded forms, encapsulated forms, and mixtures thereof.

Compounds that provide tartness may include acidulants, such as acetic acid, adipic acid, ascorbic acid, butyric acid, citric acid, formic acid, fumaric acid, glyconic acid, lactic acid, phosphoric acid, malic acid, oxalic acid, succinic acid, tartaric acid and mixtures thereof.

Compounds that provide umami or savoury flavour may include monosodium glutamate (MSG), glutamic acid, glutamates, aspartate, free amino acids, IMP (disodium 5′-inosine monophosphate) and GMP (disodium 5′-guanosine monophosphate), compounds that stimulate T1R1 and T1R3 receptors, mushroom flavour, fermented fish flavour, and muscle flavours, such as beef, chicken, pork, ostrich, venison and buffalo.

Substances that impart kokumi may include a mixture selected from: (1) gelatin and tropomyosin and/or tropomyosin peptides; (2) gelatin and paramyosin; and (3) troponin and tropomyosin and/or tropomyosin peptides, as disclosed in U.S. Pat. No. 5,679,397 to Kuroda et al., referred to above.

Compounds that provide saltiness may include conventional salts, such as sodium chloride, calcium chloride, potassium chloride, L-lysine and combinations thereof.

Compounds that provide a cooling sensation may include physiological cooling agents. A variety of well known cooling agents may be employed. For example, among the useful cooling agents are included xylitol, erythritol, dextrose, sorbitol, menthane, menthone, ketals, menthone ketals, menthone glycerol ketals, substituted p menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p menthane, 2 mercapto cyclo decanone, hydroxycarboxylic acids with 26 carbon atoms, cyclohexanamides, menthyl acetate, menthyl salicylate, N,2,3 trimethyl 2 isopropyl butanamide (WS 23), N ethyl p menthane 3 carboxamide (WS 3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter ‘isopregol’); menthone glycerol ketals (FEMA 3807, tradename FRESCOLAT® type MGA); 3-1-menthoxypropane-1,2-diol (from Takasago, FEMA 3784); and menthyl lactate; (from Haarman & Reimer, FEMA 3748, tradename FRESCOLAT® type ML), WS-30, WS-14, Eucalyptus extract (p-menthan-3,8-diol), menthol (its natural or synthetic derivatives), menthol PG carbonate, menthol EG carbonate, menthol glyceryl ether, N-tertbutyl-p-menthane-3-carboxamide, p-menthane-3-carboxylic acid glycerol ester, methyl-2-isopropylbicyclo(2.2.1)-heptane-2-carboxamide, menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

Compounds that provide warmth (warming agents) may be selected from a wide variety of compounds known to provide the sensory signal of warming to the individual user. These compounds offer the perceived sensation of warmth, particularly in the oral cavity, and often enhance the perception of flavours, sweeteners and other organoleptic components. Useful warming agents include those having at least one allyl vinyl component, which may bind to oral receptors. Examples of suitable warming agents include, but are not limited to: vanillyl alcohol n-butylether (TK-1000, supplied by Takasago Perfumery Company Ltd., Tokyo, Japan); vanillyl alcohol n-propylether; vanillyl alcohol isopropylether; vanillyl alcohol isobutylether; vanillyl alcohol N-aminoether; vanillyl alcohol isoamylether; vanillyl alcohol n-hexylether; vanillyl alcohol methylether; vanillyl alcohol ethylether; gingerol; shogaol; paradol; zingerone; capsaicin; dihydrocapsaicin; nordihydrocapsaicin; homocapsaicin; homodihydrocapsaicin; ethanol; isopropyl alcohol; iso-amylalcohol; benzyl alcohol; glycerine; chloroform; eugenol; cinnamon oil; cinnamic aldehyde; phosphate derivatives thereof; and combinations thereof.

Compounds that provide a tingling sensation also are known and referred to as ‘tingling agents.’ Tingling agents may be employed to provide a tingling, stinging or numbing sensation to the user. Tingling agents include, but are not limited to: Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; black pepper extract (piper nigrum), including the active ingredients chavicine and piperine; Echinacea extract; Northern Prickly Ash extract; and red pepper oleoresin. In some embodiments, alkylamides extracted from materials such as jambu or sanshool may be included. Additionally, in some embodiments, a sensation is created due to effervescence. Such effervescence is created by combining an alkaline material with an acidic material, either or both of which may be encapsulated. In some embodiments, an alkaline material may include alkali metal carbonates, alkali metal bicarbonates, alkaline earth metal carbonates, alkaline earth metal bicarbonates and mixtures thereof. In some embodiments, an acidic material may include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of ‘tingling’ type sensates can be found in U.S. Pat. No. 6,780,443, the entire contents of which are incorporated herein by reference for all purposes. Tingling agents are described in U.S. Pat. No. 6,780,443 to Nakatsu et al., U.S. Pat. No. 5,407,665 to McLaughlin et al., U.S. Pat. No. 6,159,509 to Johnson et al. and U.S. Pat. No. 5,545,424 to Nakatsu et al., each of which is incorporated by reference herein in its entirety.

In some embodiments, a mixture of at least one flavouring element and at least one taste potentiator is encapsulated, rather than encapsulating the taste potentiator or the flavouring element alone. Similar to above, the encapsulant may be selected to delay or increase the rate of release of the mixture of components. Any of the encapsulants described above may be employed.

For example, in some embodiments, the flavouring element(s) may be at least one intense sweetener. The intense sweetener(s) may be mixed with at least one taste potentiator, which is selected to increase the sweet taste of the intense sweetener(s). This mixture of components may then be encapsulated. Examples of suitable intense sweeteners include, but are not limited to, neotame, aspartame, Acesulfame-K, sucralose, saccharin and combinations thereof.

Alternatively or in addition to encapsulation, other binding methods may be used to bind the at least one flavouring element and at least one taste potentiator. Suitable binding methods may include, but are not limited to, co-crystallisation of the flavouring element and taste potentiator. For example, one or more taste potentiators may be co-crystallised with one or more sweeteners, such as sucrose, fructose, erythritol and combinations thereof.

As mentioned above, some embodiments may include a mixture of at least one encapsulated taste potentiator and at least one taste potentiator in its free form. The encapsulated and unencapsulated taste potentiators may be the same or different. The encapsulated taste potentiator(s) may be encapsulated by any of the materials described above. The mixture of encapsulated and unencapsulated taste potentiators may be combined with one or more flavouring elements to provide a potentiator composition. Some other embodiments provide compositions that modulate the activity of taste receptor cells in a mammal. Such compositions may include at least one active substance and at least one taste potentiator, as described above. These components may be encapsulated or unencapsulated, also as described above. The taste potentiator(s) may modulate the activity of taste receptor cells upon consumption of the composition. More specifically, taste is perceived through sensory cells located in the taste buds. Different signaling mechanisms sense the primary tastes of salty, sour, sweet, bitter and umami. Eventually a nerve impulse is triggered in the brain that is sensed as one of these primary tastes.

Taste potentiators function by modulating the activity of taste receptor cells at some point in this taste signaling pathway. For instance, in some cases, taste potentiators may bind to taste receptors, such as, for example, sweet taste receptors, which thereby enhances the perception of the sweet taste. In other embodiments, for example, taste potentiators may block taste receptors, such as, for example bitter receptors, which suppresses the perception of a bitter taste and thereby enhances the perception of a sweet taste. Taste potentiator(s), therefore, modulate the activity of taste receptor cells in mammals, which thereby enhances the perception of a given taste. This activity may enhance the perception of an active substance contained in the composition when consumed in conjunction with a taste potentiator.

In some embodiments, the potentiator composition used in the chocolate composition may be a sweetener potentiator composition including 3-HB and/or 2,4-DHB. As mentioned above, 3-HB and 2,4-DHB act synergistically with one another to enhance the sweetness of products into which the potentiators are incorporated.

The concentration of 3-HB, as calculated in the form of the free acid, generally may be up to 1500 ppm in the chocolate composition, more specifically in the range from 100 to 1500 ppm, even more specifically in the range from 200 to 1000 ppm, yet more specifically in the range from 300 to 800 ppm and most specifically in the range from 400 to 600 ppm.

The concentration of 2,4-DHB, as calculated in the form of the free acid, generally may be up to 1500 ppm in the chocolate composition, more specifically in the range from 100 to 1500 ppm, even more specifically in the range from 200 to 1000 ppm, yet more specifically in the range from 300 to 800 ppm and most specifically in the range from 400 to 600 ppm.

In general, the combined concentration of 3-HB and 2,4-DHB may be no more than 1500 ppm in the chocolate composition.

Of course, the required concentrations will depend upon the nature of the chocolate composition product to be sweetened, the level of sweetness required, the nature of the sweetener(s) in the product and the degree of enhancement required.

The chocolate compositions also may include a variety of optional additives, as provided in more detail below. Upon consumption, the flavouring element(s) and the taste potentiator(s) are released from the chocolate and provide an enhanced perception of the flavouring elements(s) contained therein.

For example, in some embodiments, the flavouring element may be at least one sweetener, such as, a sugar sweetener, sugarless bulk sweetener, intense sweetener or any combination thereof. In general, the flavouring element(s) may be present in amounts of about 0.0001% to about 75% by weight of the chocolate composition. In some embodiments, which include flavouring elements other than intense sweeteners, the flavouring element(s) may be present in amounts of about 25% to about 75% by weight of the chocolate composition. The taste potentiator(s) may be present in amounts of about 0.01% to about 10% by weight of the chocolate composition.

A variety of traditional ingredients also may be included in the chocolate compositions in effective amounts such as colouring agents, antioxidants, preservatives, sweeteners, and the like. Colouring agents may be used in amounts effective to produce the desired colour, such as for example in a sugar coating applied to the chocolate composition. The colouring agents may include pigments which may be incorporated in amounts up to about 6%, by weight of the composition. For example, titanium dioxide may be incorporated in amounts up to about 2%, and preferably less than about 1%, by weight of the composition. The colorants may also include natural food colours and dyes suitable for food, drug and cosmetic applications. These colorants are known as F.D.& C. dyes and lakes. The materials acceptable for the foregoing uses are preferably water-soluble. Illustrative non-limiting examples include the indigoid dye known as F.D.& C. Blue No. 2, which is the disodium salt of 5,5-indigotindisulfonic acid. Similarly, the dye known as F.D.& C. Green No. 1 comprises a triphenylmethane dye and is the monosodium salt of 4-[4-(N-ethyl-p-sulfoniumbenzylamino) diphenylmethylene]-[1-(N-ethyl-N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference.

In some embodiments, the chocolate composition may further include a sweetener selected from Lo han guo, stevia, monatin and combinations thereof.

Other conventional additives known to one having ordinary skill in the art also may be used in the chocolate compositions.

Additionally, in some embodiments, various confectionery configurations with multiple regions may be employed. These configurations may include, but are not limited to, liquid center-fill, powder center-fill, hard coated, soft coated, laminated, layered and enrobed. In some embodiments, the potentiator composition may be included in one region or in multiple regions of the product.

The invention will now be further illustrated by consideration of the following specific examples and related compositions.

TABLE 2
ENCAPSULATED WATER-SOLUBLE
TASTE POTENTIATOR

| Component | Weight % |
|---|---|
| Polyvinyl acetate (encapsulant) | 65.00 |
| Hydrogenated Oil | 3.75 |
| Glycerol Monostearate | 1.25 |
| Neohesperidindihydrochalcone | 30.00 |

A potentiator composition is prepared according to the formulation in Table 2 above.

The polyvinyl acetate is melted at a temperature of about 90° C. in a high shear mixer. A single or twin screw extruder, a sigma mixer or a Banbury mixer may be used. The hydrogenated oil and glycerol monostearate are added to the molten polyvinyl acetate. Neohesperidindihydrochalcone (NHDC), which is a water-soluble taste potentiator, is added to the resulting mixture and mixed under high shear to completely disperse the components. The resulting filled polymer melt is cooled and ground to a particle size of less than 420 microns. The encapsulated particles provide a slow releasing NHDC. The particles are stored in air tight containers with low humidity below 35° C. until they are incorporated into chocolate products.

TABLE 3
ENCAPSULATED MIXTURE OF
TASTE POTENTIATOR AND SWEETENER

| Component | Weight % |
|---|---|
| Polyvinyl acetate (encapsulant) | 65.00 |
| Hydrogenated Oil | 3.75 |
| Glycerol Monostearate | 1.25 |
| Aspartame | 26.00 |
| Neohesperidindihydrochalcone | 4.00 |

A potentiator composition is prepared according to the formulation in Table 3 above.

The polyvinyl acetate is melted at a temperature of about 90° C. in a high shear mixer. A single or twin screw extruder, a sigma mixer or a Banbury mixer may be used. The hydrogenated oil and glycerol monostearate are added to the molten polyvinyl acetate. NHDC, which is a water-soluble taste potentiator, and aspartame are added to the resulting mixture and mixed under high shear to completely disperse the components. The resulting filled polymer melt is cooled and ground to a particle size of less than 420 microns. The encapsulated particles provide a delayed and combined release mixture of NHDC and aspartame. The particles are stored in air tight containers with low humidity below 35° C. until they are incorporated into chocolate products.

TABLE 4
ENCAPSULATED LOW WATER-SOLUBLE
TASTE POTENTIATOR

| Component | Weight % |
|---|---|
| Maltitol (encapsulant) | 90.00 |
| Sweetener Potentiator | 9.00 |
| Glycerol Monostearate | 1.00 |

A potentiator composition is prepared according to the formulation in Table 4 above.

The maltitol is melted at a temperature of about 140° C. in a high shear mixer. A single or twin screw extruder, a sigma mixer or a Banbury mixer may be used. The glycerol monostearate is added to the molten maltitol. The sweetener potentiator, which exhibits low solubility in water, is added to the resulting mixture and mixed under high shear to completely disperse the components. The resulting melt is cooled and ground to a particle size of less than 590 microns. The encapsulation provides an increased release rate of the sweetener potentiator upon consumption. The encapsulated particles are stored in air tight containers with low humidity below 35° C. until they are incorporated into chocolate products.

TABLE 5
ENCAPSULATED LOW WATER-SOLUBLE
TASTE POTENTIATOR

| Component | Weight % |
|---|---|
| Water | 60.00 |
| Maltitol (encapsulant) | 34.00 |
| Acetylated monoglyceride | 3.00 |
| Sweetener Potentiator | 3.00 |

A potentiator composition is prepared according to the formulation in Table 5 above.

The maltitol and acetylated monoglyceride are dissolved in water at a temperature of about 70° C. in an agitated vessel. The sweetener potentiator, which exhibits low solubility in water, is dispersed in the resulting solution. The solution, or suspension, is spray dried using a spray dryer fitted with an air atomized nozzle (stationary or rotary) at about 105° C. to form encapsulated particles. The encapsulation provides an increased release rate of the substantially water-insoluble sweetener potentiator upon consumption. The encapsulated particles are stored in air tight containers with low humidity below 35° C. until they are incorporated into chocolate products.

TABLE 6
ENCAPSULATED LOW WATER-SOLUBLE
TASTE POTENTIATOR

| Component | Weight % |
|---|---|
| Beta-cyclodextrin (encapsulant) | 25.00 |
| Sweetener Potentiator | 5.00 |
| Water | 50 |
| Ethanol | 20.00 |

A potentiator composition is prepared according to the formulation in Table 6 above.

The beta-cyclodextrin is dissolved in water at a temperature of about 60° C. The sweetener potentiator, which exhibits low solubility in water, is dissolved completely in the ethanol and the resulting solution is added to the beta-cyclodextrin solution and stirred for about three hours. The resulting solution of beta-cyclodextrin complex is spray dried using a spray dryer fitted with an air atomized nozzle (stationary or rotary) at about 60° C. to form encapsulated particles. The encapsulation provides an increased release rate of the substantially water-insoluble sweetener potentiator upon consumption. The encapsulated particles are stored in air tight containers with low humidity below 35° C. until they are incorporated into chocolate products.

### Sucrose Equivalent Value (SEV)

One method of measuring the perceived sweetness of a solution is to match it with a stock sucrose solution of known concentration. In the present experiments, the compound of interest is added at a predetermined concentration to a pH 3.2 buffered solution containing 5% sucrose. A number of expert panel members then taste the solution and compare it to a battery of stock sucrose solutions ranging from 3% to 15% at increments of 1%. Each panel member decides which sucrose solution is equisweet with the solution containing the compound of interest. The mean value is then reported as the SEV. Results are reported to 1 decimal place.

### Dose Response Curve for 3-Hydroxybenzoic Acid

In accordance with this methodology, 3-HB was added to a pH 3.2 buffered solution containing 5% sucrose to produce solutions containing from 0 to 1000 ppm 3-HB in 100 ppm increments. The SEV for each solution was plotted on a graph to produce a dose response curve (FIG. 1), from which it can be seen that 3-HB enhances the sweetness of the sucrose solution within this range. From FIG. 1 it is apparent that as the dosage of 3-HB increases so does the sweetness of the resultant solution. However the effect is non-linear with each incremental addition having a diminishing effect. The maximum sweetness attainable would appear to be about 7.9% SEV (based on a 5% sucrose solution).

### Dose Response Curve for 2,4-Dihydroxybenzoic Acid

The same methodology as described in Example 6 was repeated with 2,4-DHB in place of 3-HB, to produce the dose response curve for 2,4-DHB (FIG. 2). From FIG. 2 it can be seen that 2,4-DHB also enhances the sweetness of the sucrose solution but there is little difference between the 400 ppm solution (SEV 6.5%) and the 1000 ppm solution (SEV 6.7%). The maximum attainable sweetness would appear to be about 6.7% SEV (based on a 5% sucrose solution).

### Sucrose Reduction Method

An alternative method of measuring perceived sweetness is to determine how much sucrose can be replaced through the use of the compound of interest without any Perceived loss of sweetness. In the present experiments the control was a pH 3.2 buffered solution containing 10% sucrose. The compound of interest is added at a predetermined concentration to a number of sucrose solutions containing from 5% to 10% sucrose at increments of 0.5%. Each panel member tastes each of the solutions, compares it to the control sample and decides which solutions are equisweet. For example, if the 8% sucrose solution containing the compound of interest is equisweet with the control, then the sucrose reduction achieved by the compound of interest is 20%.

### Effect of Relative Concentration on Sucrose Reduction for 3-HB, 2,4-DHB Mixtures

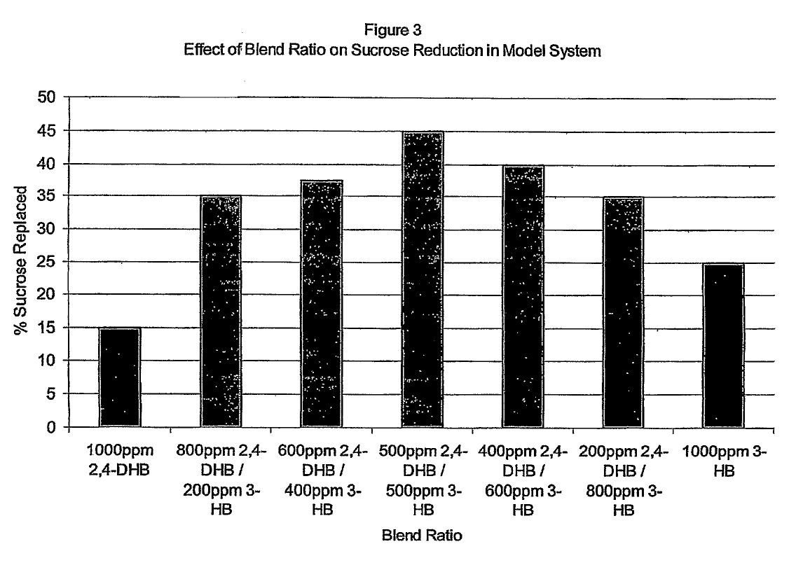

A series of sucrose solutions were prepared containing 3-HB and 2,4-DHB at a combined concentration of 1000 ppm. Each solution was evaluated using the sucrose reduction method described above to determine how much sucrose could be replaced without noticeable loss of sweetness. The results are shown in FIG. 3.

As shown in FIG. 3, the greatest reduction is observed when equal quantities of 3-HB and 2,4-DHB are employed. This ratio results in the very significant sucrose reduction of 45%. This figure is highly surprising considering that the use of 1000 ppm of 3-HB or 2,4-DHB individually results in a reduction of just 25% and 15% respectively. The other ratios 3-HB:2,4-DHB (8:2, 6:4, 4:6 and 2:8) are also very effective; each combination results in a sucrose reduction of at least 35%.

### Effect of Concentration on Sucrose Reduction for 1:1 3-HB:2,4-DHB Mixtures

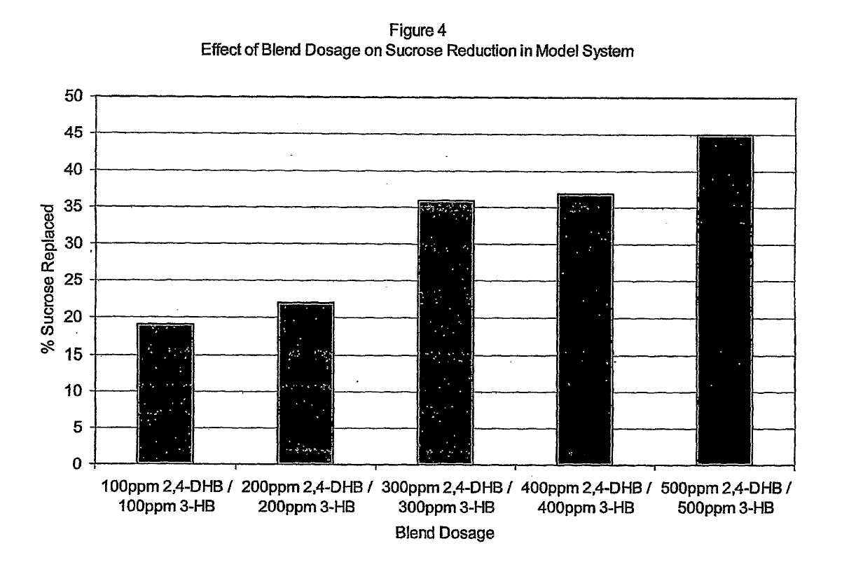

A series of sucrose solutions were prepared containing equal quantities of 3-HB and 2,4-DHB, at a combined concentration of 200, 400, 600, 800 and 1000 ppm. Each solution was evaluated using the sucrose reduction method described in Example 8 above to determine how much sucrose could be replaced without noticeable loss of sweetness. The results are shown in FIG. 4.

Increasing the total quantity of 3-HB and 2,4-DHB while retaining a 1:1 ratio increases the sweetness enhancing effect. As shown above 500 ppm 3-HB+500 ppm 2,4-DHB results in 45% of the sucrose being replaced without loss of sweetness. However, the combination of 3-HB and 2,4-DHB is effective even at very low concentration. The use of just 200 ppm of each of 3-HB and 2,4-DHB allows the sucrose content to be reduced by 22%.

### Sucrose Equivalent Values for Various Benzoic Acid Derivatives and Combinations Thereof

500 ppm of a sweetener potentiator was added to a pH 3.2 buffered solution containing 5% sucrose and the SEV of the resultant solution determined. The results are shown in Table 8.

TABLE 8

| Sweetness potentiator | SEV (%) |
|---|---|
| 2-hydroxybenzoic acid (2-HB) | 5.6 |
| 3-hydroxybenzoic acid (3-HB) | 6.9 |
| 4-hydroxybenzoic acid (4-HB) | 5.2 |
| 2,3-dihydroxybenzoic acid (2,3-DHB) | 6.3 |
| 2,4-dihydroxybenzoic acid (2,4-DHB) | 6.5 |
| 2,5-dihydroxybenzoic acid (2,5-DHB) | 5.3 |
| 2,6-dihydroxybenzoic acid (2,6-DHB) | 5.3 |
| 3,4-dihydroxybenzoic acid (3,4-DHB) | 6.4 |
| 3,5-dihydroxybenzoic acid (3,5-DHB) | 5.3 |
| 2,3,4-trihydroxybenzoic acid (2,3,4-THB) | 5.4 |
| 2,4,6-trihydroxybenzoic acid (2,4,6-THB) | 5.4 |
| 3,4,5-tryhydroxybenzoic acid (3,4,5-THB) | 5.1 |

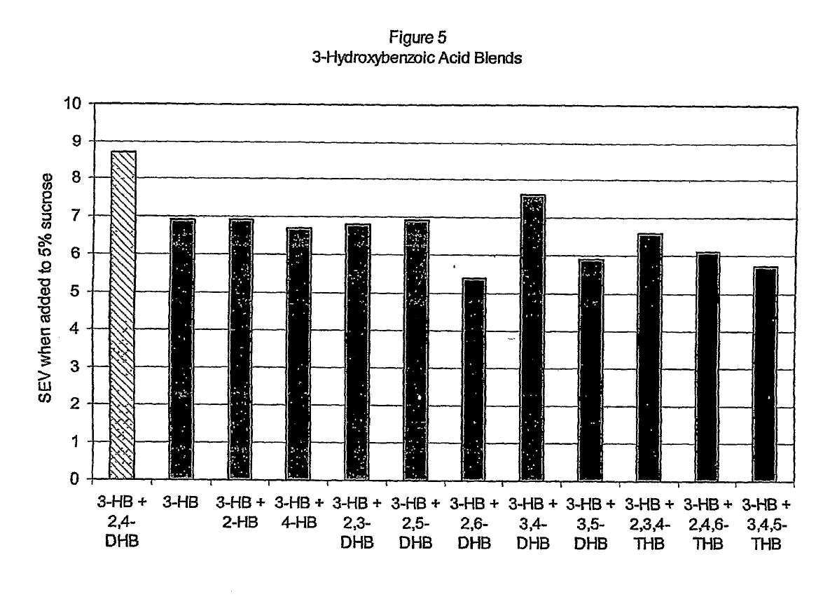

500 ppm of the sweetener potentiator then was added to a 5% sucrose solution containing 500 ppm 3-HB to produce a series of solutions. The SEV for each solution was determined and the results are shown in FIG. 5. As shown in FIG. 5, the composition of one embodiment (hatched) is considerably more effective than any other combination with an SEV of 8.7%. The use of 500 ppm of 3-HB alone results in an SEV of 6.9% whereas in all cases but two (2,4-DHB and 3,4-DHB) the addition of a second sweetener potentiator results in a little change or even a decrease in SEV. This is highly surprising considering that all of the potentiators are shown to have SEVs greater than 5%.

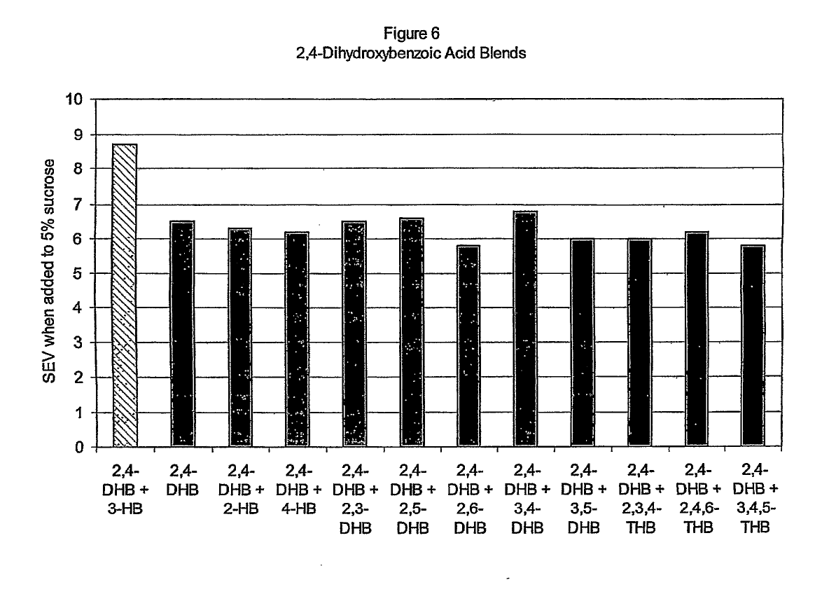

The methodology was repeated to produce a series of solutions containing 500 ppm 2,4-DHB and 500 ppm of a second sweetener potentiator. The SEV for each solution was determined and the results are shown in FIG. 6.

Again the combination (hatched) of 3-HB and 2,4-DHB results in by far the greatest sweetness enhancement. It might be expected that 2-HB or 4-HB could be used in place of 3-HB but these combinations result in solutions with SEVs of just 6.3% and 6.2% respectively. The use of 500 ppm 2,4-DHB alone results in a solution with an SEV of 6.5%. The addition of a second sweetener potentiator appears to inhibit its effect in most cases and only the addition of 3-HB has a significant positive effect.

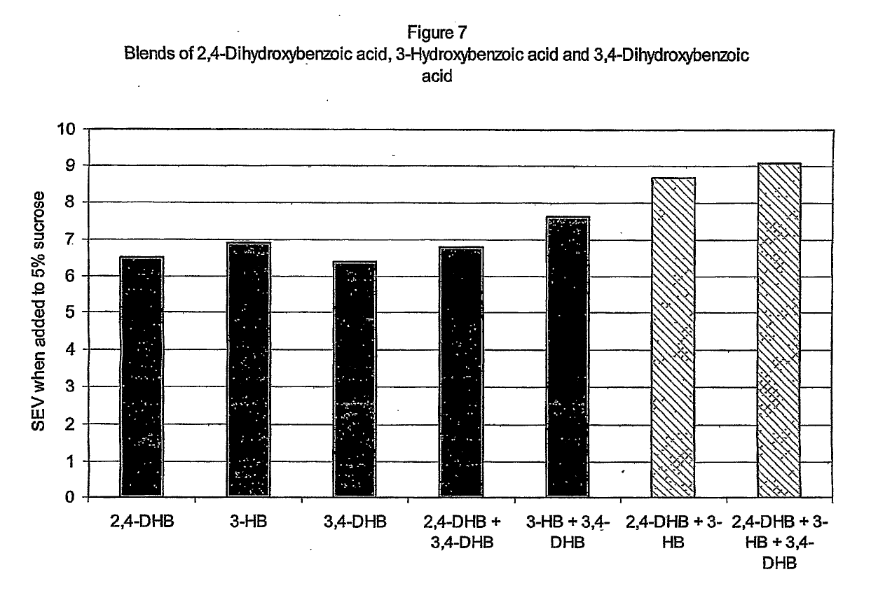

500 ppm of 3-HB, 500 ppm of 2,4-DHB and 500 ppm of 3,4-dihydroxybenzoic acid (3,4-DHB) were added to a pH 3.2 buffered solution containing 5% sucrose and the SEV determined. The results are shown in FIG. 7 together with other combinations of 3-HB, 2,4-DHB and 3,4-DHB for comparison. The solution containing the combination of 3-HB and 2,4-DHB (hatched) has a much higher SEV (8.7%) than the combination of either 3,4-DHB and 3-HB (7.6%) or the combination of 3,4-DHB and 2,4-DHB (6.8%). The three-way combination of the embodiment (hatched) is better still with an SEV of 9.8%.

### Comparison of Different Forms of 2,4-DHB

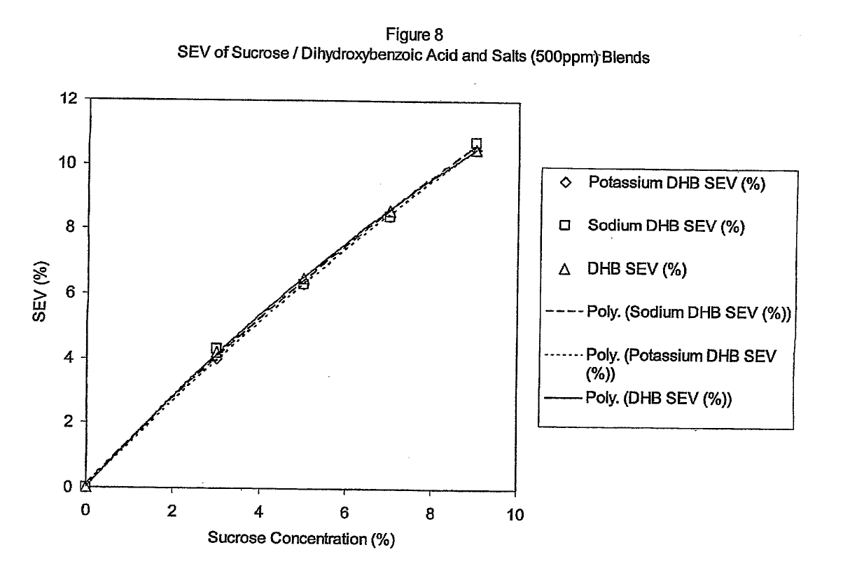

Buffered solutions of pH 3.2 were prepared containing 0%, 3%, 5%, 7% and 9% sucrose. 500 ppm of 2,4-DHB acid, 500 ppm of the sodium salt of 2,4-DHB and 500 ppm of the potassium salt of 2,4-DHB were added individually to each of the sucrose solutions. The SEV for each of the solutions was then determined. The results are shown in FIG. 8.

As shown in FIG. 8, the addition of 2,4-DHB enhances the sweetness of the sucrose solution in every case regardless of the original sucrose solution or whether the acid, sodium salt or potassium salt is employed. The results for the acid, sodium salt and potassium salt are almost identical indicating that the sweetener potentiator composition may be prepared from the acids and/or from their comestible salts.

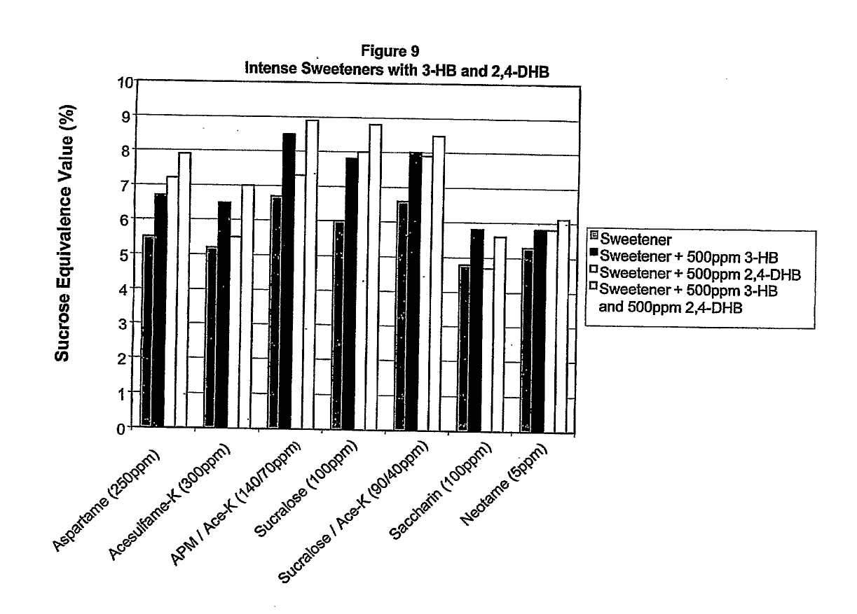

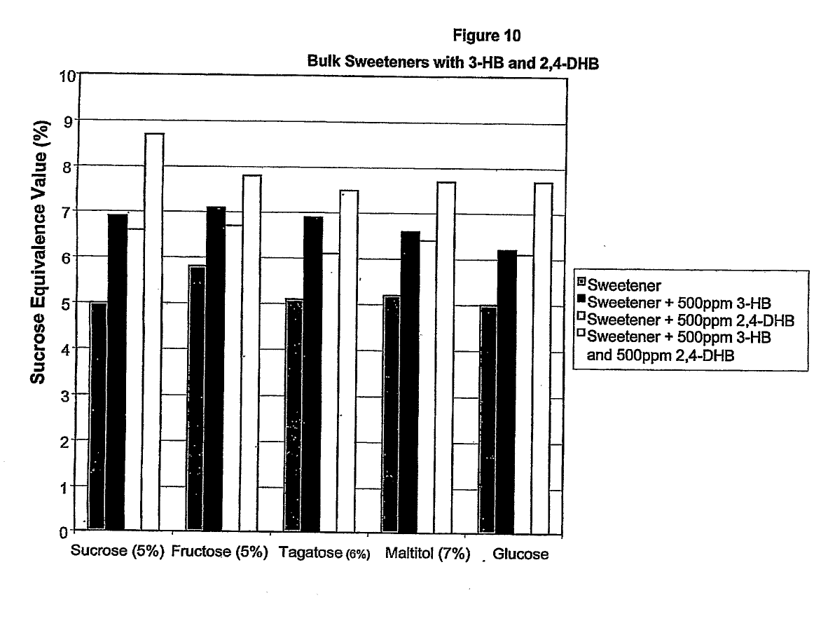

Sweetness Enhancing Effect of 3-HB and 2,4-DHB on Non-Sucrose Sweeteners Solutions were prepared at a pH of 3.2 containing a sufficient quantity of a non-sucrose sweetener so that the resulting solution had an SEV of about 5%. The SEV of each sweetener solution was then evaluated after the addition 500 ppm of 3-HB, the addition of 500 ppm of 2,4-DHB and the addition of both 500 ppm 3-HB and 2,4-DHB. The results are shown in FIGS. 9 and 10.

FIG. 9 shows the results of various intense sweeteners with 3-HB, 2,4-DHB and combinations thereof. As shown in FIG. 9, the combination of 3-HB and 2,4-DHB with aspartame has a significant effect on SEV, which is greater than the use of either 3-HB or 2,4-DHB separately. Similarly, the combination of 3-HB and 2,4-DHB enhances the perceived sweetness of the acesulfame-K, aspartame/acesulfame-K, sucralose, sucralose/acesulfame-K, saccharin and neotame solutions. With respect to the saccharin solution, however, 3-HB enhances the sweetness to a greater degree alone than in combination with 2,4-DHB.

FIG. 10 shows the results of various bulk sweeteners with 3-HB, 2,4-DHB and combinations thereof. As seen in FIG. 10, the combination of 3-HB and 2,4-DHB increases the SEV of the resultant solution when used with sucrose, fructose, tagatose, maltitol or glucose to a greater extent than either 3-HB or 2,4-DHB separately.

### Sucrose Equivalent Values for Aminobenzoic Acid Derivatives

500 ppm of 3-aminobenzoic acid and 500 ppm of 4-aminobenzoic acid were individually added to separate pH 3.2 buffered solutions containing 5% sucrose and the SEVs of the resultant solutions were determined. The SEV of 3-aminobenzoic acid was about 7%, i.e., increased the sweetness intensity of 5% sucrose to about 7%. The SEV of 4-aminobenzoic acid was about 5.5-6%, i.e., increased the sweetness intensity of 5% sucrose to about 5.5-6%.

### EXAMPLES 1 TO 6

### Taste Potentiators in Chocolate

Chocolate compositions were prepared according to Table 9. The results are shown in Table 10.

TABLE 9

| | Comparative | | | |
|---|---|---|---|---|
| | Example 1 | Example 1 | Example 2 | Example 3 |
| | wt % | wt % | wt % | wt % |
| Maltitol | 46.00 | 45.95 | 45.95 | 45.95 |
| Cocoa butter | 19.00 | 19.00 | 19.00 | 19.00 |
| Milk fat | 3.50 | 3.50 | 3.50 | 3.50 |
| Skimmed milk powder | 18.00 | 18.00 | 18.00 | 18.00 |
| Cocoa mass | 13.50 | 13.50 | 13.50 | 13.50 |
| 2,4-dihydroxybenzoic | — | 0.05 | — | — |
| acid | | | | |
| 3-hydroxybenzoic acid | — | — | 0.05 | — |
| 3-aminobenzoic acid | — | — | — | 0.05 |

| | Example 4 | Example 5 | Example 6 |
|---|---|---|---|
| | wt % | wt % | wt % |
| Maltitol | 45.90 | 45.95 | 45.95 |
| Cocoa butter | 19.00 | 19.00 | 19.00 |
| Milk fat | 3.50 | 3.50 | 3.50 |
| Skimmed milk powder | 18.00 | 18.00 | 18.00 |
| Cocoa mass | 13.50 | 13.50 | 13.50 |
| 2,4-dihydroxybenzoic | 0.05 | 0.05 | — |
| acid | | | |
| 3-hydroxybenzoic acid | 0.05 | — | 0.05 |
| 3,4-dihydroxybenzoic | — | −0.05 | 0.05 |
| acid | | | |

TABLE 10

| | |
|---|---|
| Comp. Ex 1 | Sweet upfront but sweetness decreases leaving some bitterness. Slightly |
| | drying and throat-catching. Cooling. |
| Example 1 | Sweeter and creamier than the control. Less drying and throat-catching. |
| Example 2 | Sweeter and creamier than the control. Less drying and throat-catching. |
| | Slightly less cooling. |
| Example 3 | Slightly sweeter and fuller flavour profile than the control. |
| Example 4 | Sweeter than the control and the sweetness has a longer duration. |
| | Creamier, more rounded flavour. Slightly less cooling. |
| Example 5 | Sweeter and more rounded flavour compared with the control. |
| Example 6 | Sweeter than the control but less improvement in flavour compared to Test 5. |

### EXAMPLE 7

### Taste Potentiators in Low-Cost Milk Chocolate

A chocolate composition comprising a taste potentiator, and a control sample, were prepared as shown in Table 11. The samples were evaluated by a panel trained in tasting. Typical comments on Example 7 relative to Comparative Example 1 were: “more creamier, more flavourful”; “more caramelic flavour, longer lasting flavour, a little more sweet”; “sweeter, flavour improved”; and “sweeter, flavour more chocolatey, less cocoa-like”.

TABLE 11

| | Comparative | Example 7 |
|---|---|---|
| | Example 2 wt % | wt % |
| Sugar | 48.33 | 48.29 |
| Full cream milk powder | 23.01 | 22.99 |
| Butter fat | 0.64 | 0.64 |
| Cocoa liquor | 10.82 | 10.81 |
| Cocoa butter (3B blend) | 15.94 | 15.92 |
| YN50 flavouring | 1.2 | 1.2 |
| PGPR | 0.06 | 0.06 |
| 2,4-Dihydroxybenzoic acid | — | 0.05 |
| 3-Hydroxybenzoic acid | — | 0.05 |

### EXAMPLES 8 AND 9

### Taste Potentiators in Dark Chocolate

Two chocolate compositions comprising a taste potentiator, and a control sample, were prepared as shown in Table 12.

TABLE 12

| | Comparative | Example 8 | Example 9 |
|---|---|---|---|
| | Example 3 wt % | wt % | wt % |
| Granulated sugar no. 2 | 36.00 | 35.98 | 35.96 |
| Ghana liquor | 39.65 | 39.63 | 39.61 |
| Cocoa powder 1/12% fat | 7.85 | 7.85 | 7.84 |
| Raw cocoa butter | 12.85 | 12.84 | 12.84 |
| Butterfat | 3.30 | 3.3 | 3.3 |
| YN100 | 0.25 | 0.25 | 0.25 |
| Vanillin | 0.10 | 0.1 | 0.1 |
| 2,4-Dihydroxybenzoic acid | — | 0.025 | 0.05 |
| 3-Hydroxybenzoic acid | — | 0.025 | 0.05 |

### EXAMPLE 10

### Taste Potentiators in Sugar-Free Chocolate

A chocolate composition comprising a taste potentiator, and a control sample, were prepared as shown in Table 13.

TABLE 13

| | Comparative | Example 10 |
|---|---|---|
| | Example 4 wt % | wt % |
| SMP | 16.61 | 16.61 |
| EOH | 15.30 | 15.30 |
| Whey | 1.75 | 1.75 |
| Polydextrose | 13.11 | 13.11 |
| Maltitol | 12.24 | 12.14 |
| Caramelised SMP | 1.31 | 1.31 |
| Milk fat | 5.42 | 5.42 |
| Cocoa liquor | 16.64 | 16.64 |
| YN50 flavouring | 1.28 | 1.28 |
| PGPR | 0.08 | 0.08 |
| Cocoa butter | 16.27 | 16.27 |
| Sucralose | 0.0061 | 0.0061 |
| Acesulfame-K | 0.0064 | 0.0064 |
| 2,4-Dihydroxybenzoic acid | — | 0.05 |
| 3-Hydroxybenzoic acid | — | 0.05 |

### EXAMPLES 11 TO 24

### Taste Potentiators in Sugar-Free Chocolate

A chocolate composition comprising a taste potentiator composition is prepared as shown in Table 14. Each taste potentiator composition contains the proportions of ingredients shown in Table 15.

TABLE 14

| | wt % |
|---|---|
| Cocoa liquor | 13.30 |
| Cocoa butter | 13.10 |
| Milk fat | 13.50 |
| Skimmed milk powder | 14.00 |
| Erythritol | 24.70 |
| Maltitol | 8.50 |
| Polydextrose | 8.80 |
| Glucidex ® (maltodextrin) | 6.30 |
| Whey protein isolate | 6.30 |
| Ammonium phosphatides | 1.00 |
| (emulsifier) | |
| PGPR (polyglycerol | 0.40 |
| polyricinoleate, emulsifier) | |
| Taste potentiator (Table 15) | 0.1 |

TABLE 15

| | 2,4-DHB | 3,4-DHB | 3-HB | 3-AB |
|---|---|---|---|---|
| | wt % | wt % | wt % | wt % |
| Example 11 | 100 | — | — | — |
| Example 12 | — | 100 | — | — |
| Example 13 | — | — | 100 | — |
| Example 14 | — | — | — | 100 |
| Example 15 | 50 | 50 | — | — |
| Example 16 | 50 | — | 50 | — |
| Example 17 | 50 | — | — | 50 |
| Example 18 | — | 50 | 50 | — |
| Example 19 | — | 50 | — | 50 |
| Example 20 | — | — | 50 | 50 |
| Example 21 | 33 | 33 | 33 | — |
| Example 22 | 33 | 33 | — | 33 |
| Example 23 | 33 | — | 33 | 33 |
| Example 24 | 25 | 25 | 25 | 25 |

(3-AB = 3-aminobenzoic acid).

1. A milk, dark or white chocolate composition comprising at least one taste potentiator.

2. A chocolate composition comprising at least one sugar-free sweetener and at least one taste potentiator.

3. A chocolate composition as claimed in claim 2, wherein the at least one sugar-free sweetener comprises a sugar alcohol.

4. A chocolate composition as claimed in claim 1, comprising a plurality of discrete taste-modifying particles, each taste-modifying particle comprising the at least one taste potentiator.

5. A chocolate composition as claimed in claim 4, wherein each taste-modifying particle is encapsulated in an encapsulant.

6. A chocolate composition as claimed in claim 4, wherein each taste-modifying particle is crystalline.

7. A chocolate composition as claimed in claim 4, wherein each taste-modifying particle further comprises a flavouring element.

8. A chocolate composition as claimed in claim 7, wherein the flavouring element comprises a sugar-free sweetener.

9. A chocolate composition as claimed in claim 1, wherein the at least one potentiator comprises 3-hydroxybenzoic acid (3-HB) and/or comestible salts thereof.

10. A chocolate composition as claimed in claim 1, wherein the at least one taste potentiator comprises 2,4-dihydroxybenzoic acid (2,4-DHB) and/or comestible salts thereof.

11. A chocolate composition as claimed claim 1, wherein the at least one taste potentiator comprises a mixture comprising 2,4-dihydroxbenzoic (2,4-DHB) and/or comestible salts thereof, and 3-hydrobenzoic acid (3-HB) and/or comestible salts thereof.

12. A chocolate composition as claimed in claim 2, comprising a plurality of discrete taste-modifying particles, each taste-modifying particle comprising the at least one taste potentiator.

13. A chocolate composition as claimed in claim 12, wherein each taste-modifying particle is encapsulated in an encapsulant.

14. A chocolate composition as claimed in claim 12, wherein each taste-modifying particle is crystalline.

15. A chocolate composition as claimed in claim 14, wherein each taste-modifying particle further comprises a flavouring element.

16. A chocolate composition as claimed in claim 2, wherein the at least one potentiator comprises 3-hydroxybenzoic acid (3-HB) and/or comestible salts thereof.

17. A chocolate composition as claimed in claim 2, wherein the at least one taste potentiator comprises 2,4-dihydroxybenzoic acid (2,4-DHB) and/or comestible salts thereof.

18. A chocolate composition as claimed in claim 2, wherein the at least one taste potentiator comprises a mixture comprising 2,4-dihydroxbenzoic (2,4-DHB) and/or comestible salts thereof, and 3-hydrobenzoic acid (3-HB) and/or comestible salts thereof.
